(19) United States
(12) Patent Application Publication
(10) Pub. No.: US 2026/0172893 A1
(43) Pub. Date: Jun. 18, 2026

(54) REPORTING BUFFER STATUS REPORT (BSR) INFORMATION IN A MULTI-STATION (STA) BLOCK ACKNOWLEDGEMENT (BA)

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/424,697

(22) Filed: Dec. 18, 2025

Related U.S. Application Data
(60) Provisional application No. 63/735,695, filed on Dec. 18, 2024.
(60) Provisional application No. 63/767,336, filed on Mar. 5, 2025.
(60) Provisional application No. 63/795,817, filed on Apr. 28, 2025.

(51) Int. Cl. H04W 28/02

(52) U.S. Cl. CPC H04W 28/0278

(57) ABSTRACT

Reporting Buffer Status Report (BSR) information in Multi-Station (STA) Block Acknowledgement (BA) may be provided. A computing device may receive a Buffer Status Report Poll (BSRP) trigger frame. Next, a Multi-Station (STA) Block Acknowledgement (BA) frame may be created. The Multi-STA BA frame may comprise Buffer Status Report (BSR) information. Then, in response to receiving the BSRP trigger frame, the Multi-STA BA frame may be transmitted.

### RELATED APPLICATION

Under the provisions of 35 U.S.C. § 119(e), Applicant claims the benefit of and priority to U.S. Provisional Application No. 63/735,695, filed Dec. 18, 2024, U.S. Provisional Application No. 63/767,336, filed Mar. 5, 2025, and U.S. Provisional Application No. 63/795,817, filed Apr. 28, 2025, the complete disclosures of each of which are incorporated herein by reference.

### TECHNICAL FIELD

The present disclosure relates generally to providing Reporting Buffer Status Report (BSR) information in a Multi-Station (STA) Block Acknowledgement (BA).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Reporting Buffer Status Report (BSR) information in a Multi-Station (STA) Block Acknowledgement (BA);

FIG. 2 is a flow chart of a method for providing BSR information in a Multi-STA BA;

FIG. 3 illustrates a Multi-Station (STA) Block Acknowledgement (BA) frame;

FIG. 4 illustrates a BSR per Association Identifier (AID) Traffic Identifier (TID) information field;

FIG. 5 illustrates values for an AID11 field;

FIG. 6 illustrates content of a BSR control subfield;

FIG. 7 illustrates a BA starting sequence control field;

FIG. 8 illustrates a size of a BA bitmap or BSR subfield;

FIG. 9 is a block diagram of a computing device;

FIG. 10 illustrates a Multi-STA BA frame;

FIG. 11 illustrates a BSR Per AID TID information field;

FIG. 12 illustrates a feedback per AID TID information field;

FIG. 13 illustrates a Multi-STA BA;

FIG. 14 illustrates a feedback per AID TID information field;

FIG. 15 illustrates a feedback per AID TID information field;

FIG. 16 illustrates a feedback per AID TID information field;

FIG. 17 illustrates a feedback per AID TID information field;

FIG. 18 illustrates a feedback per AID TID information field;

FIG. 19 illustrates a feedback per AID TID information field;

FIG. 20 illustrates a feedback per AID TID information field; and

FIG. 21 illustrates a feedback per AID TID information field.

### DETAILED DESCRIPTION

### Overview

Reporting Buffer Status Report (BSR) information in Multi-Station (STA) Block Acknowledgement (BA) may be provided. A computing device may receive a Buffer Status Report Poll (BSRP) trigger frame. Next, a Multi-Station (STA) Block Acknowledgement (BA) frame may be created. The Multi-STA BA frame may comprise Buffer Status Report (BSR) information. Then, in response to receiving the BSRP trigger frame, the Multi-STA BA frame may be transmitted.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

To address In-Device Coexistence (IDC) issues, a process may be defined for a Station (STA) (i.e., a client device) to report its dynamic unavailability within a TxOP to an AP, by providing its unavailability information in an Initial Control Response (ICR) frame sent in response to an Initial Control Frame (ICF), when the STA is a TxOP responder. Standards bodies may be considering using Buffer Status Report Poll (BSRP) Trigger frame as ICF and using the Multi-STA Block Acknowledgement (BA) as ICR.

When an AP sends a BSRP trigger frame or a BSRP NTB (Non-trigger based) trigger frame, it may be asking the STA to provide Buffer Status Report (BSR) information that may then be used for Uplink Multi-User (UL MU) triggering. The STA may provide BSR information in one or more Quality-of-Service (QoS) null frames in either: i) the QoS control field; or ii) the BSR control field in the A-control field in a high throughput (HT) control field. In the description here, the BSRP trigger frame generically refers to either a BSRP Trigger frame or a BSRP NTB Trigger frame.

Given that standards may be defined to use Multi-STA BA as an ICR to provide unavailability info, in response to a BSRP trigger frame (i.e., ICF), two cases may be possible: Case 1) when the BSRP trigger frame solicits a response in Trigger-Based Physical Protocol Data Unit (TB PPDU) format, then a non-AP STA may use aggregation and include both Multi-STA BA frame and QoS null frame(s) with BSR information in an Aggregated Media Access Control (MAC) Protocol Data Unit (A-MPDU); and Case 2) when the BSRP trigger frame solicits a response in non-HT (duplicate) PPDU format, then aggregation may not be used (or possible) and if Multi-STA BA is sent in response, then BSR information may not be provided by the STA since QoS null frames can't be aggregated with Multi-STA BA frame. This may be an issue because the AP may not have a way to poll a STA for BSR information and as such may be missing critical information to perform Uplink (UL) triggering for STAs in such cases.

Embodiments of the disclosure may provide an enhancement to the Multi-STA BA frame to provide BSR information to the AP, in the case when the STA is providing its unavailability feedback (e.g., due to IDC) to the AP, and may only send non-HT (duplicate) PPDU. This may be desirable to reduce any adverse impact on the efficiency of an AP's UL trigger scheduling in this case, due to lack of BSR info. In one embodiment, the BSR information may be provided in the Multi-STA BA frame independent of whether the Multi-STA BA response is sent in non-HT (duplicate) PPDU or not, in other words, the BSR information may be provided in the ICR independent of the type of the BSRP trigger frame (whether a BSRP Trigger frame or a BSRP NTB Trigger frame).

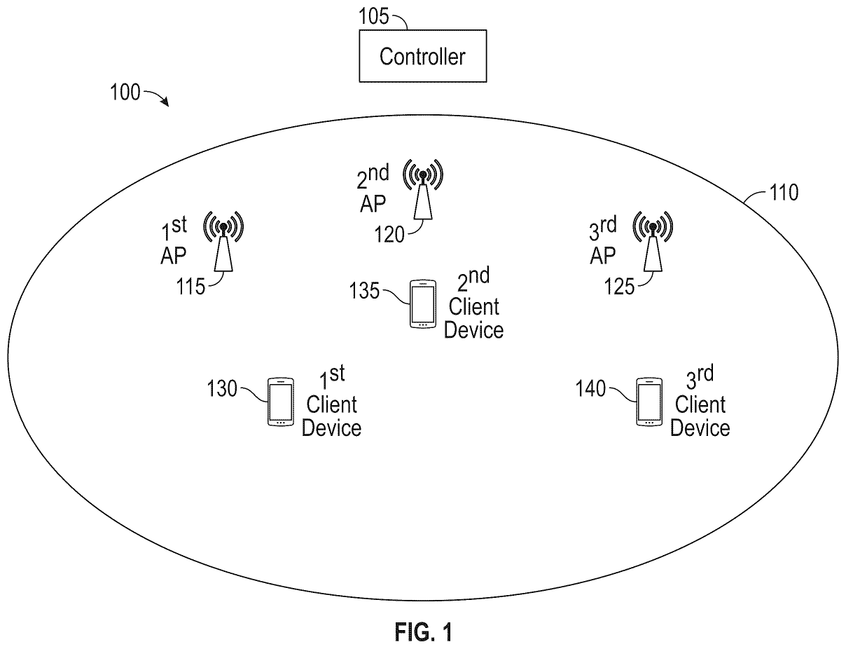

FIG. 1 shows an operating environment 100 for providing Buffer Status Report (BSR) information in a Multi-Station (STA) Block Acknowledgement (BA). As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs) as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide Reporting Buffer Status Report (BSR) information in a Multi-Station (STA) Block Acknowledgement (BA).

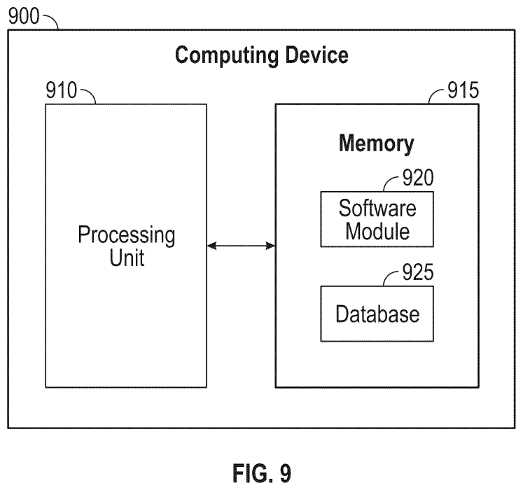

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 9, the elements of operating environment 100 may be practiced in a computing device 900.

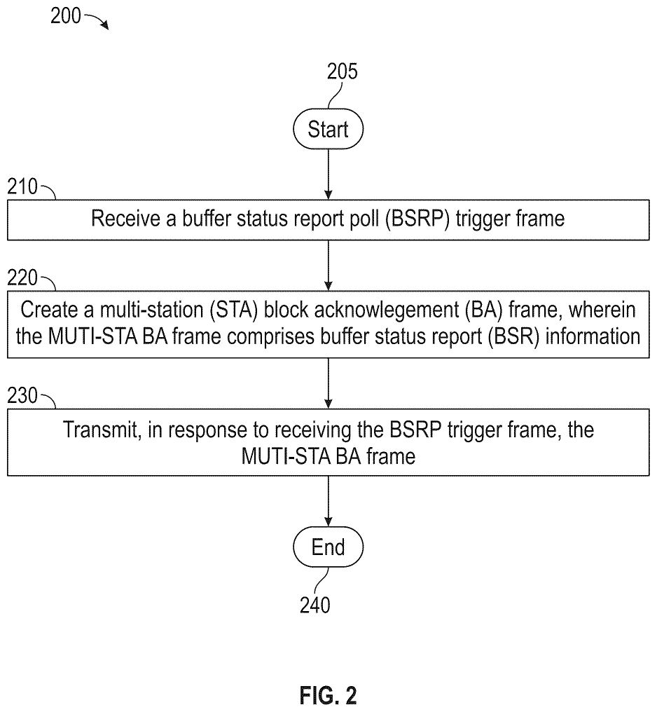

FIG. 2 is a flow chart setting forth the general stages involved in a method 200 consistent with embodiments of the disclosure for providing Buffer Status Report (BSR) information in Multi-Station (STA) Block Acknowledgement (BA). Method 200 may be implemented using a computing device 900 as described in more detail below with respect to FIG. 9. Computing device 900 may be embodied, for example, by any of the plurality of client devices (e.g., first client device 130) described above. Ways to implement the stages of method 200 will be described in greater detail below.

Method 200 may begin at starting block 205 and proceed to stage 210 where computing device 900 may receive a Buffer Status Report Poll (BSRP) trigger frame (either a BSRP Trigger frame or a BSRP NTB Trigger frame). In one case, the BSRP trigger frame may explicitly indicate that the BSR information is requested in the response. The BSRP trigger frame may be sent by the AP to a non-AP STA (or to another AP in a Coordinated Time Division Multiple Access (Co-TDMA) use case as described later). When a non-AP STA (e.g., first client device 130) cannot provide Buffer Status Report (BSR) information in a Physical Layer Protocol Data Unit (PPDU) that is sent in response to a BSRP trigger frame (e.g., because it cannot aggregate a QoS Null frame to provide BSR information with the Multi-STA BA frame), embodiments of the disclosure may provide that the Multi-STA BA frame in that PPDU provides the BSR information itself.

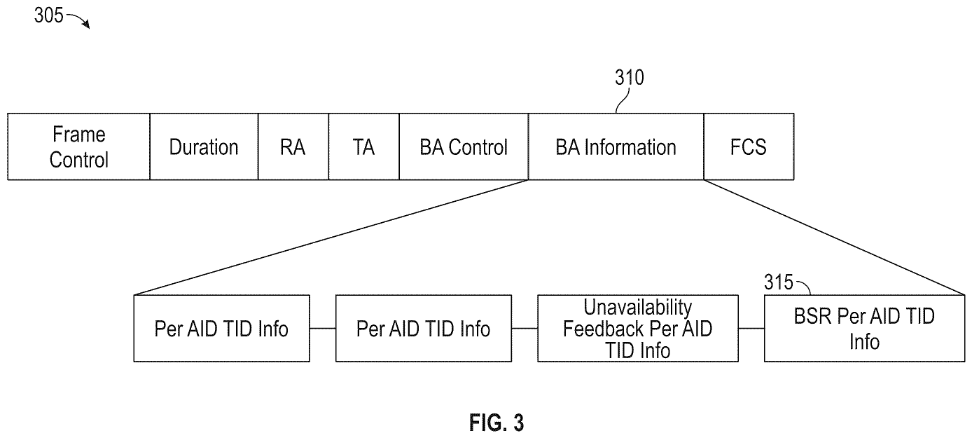

From stage 210, where computing device 900 receives the BSRP trigger frame, method 200 may advance to stage 220 where computing device 900 may create a Multi-Station (STA) Block Acknowledgement (BA) frame 305 as shown in FIG. 3. Multi-STA BA frame 305 may comprise Buffer Status Report (BSR) information (e.g., in a BA information field 310). For example, embodiments of the disclosure may provide a Per Association Identifier (AID) Traffic Identifier (TID) information field to carry BSR information, shown as BSR Per AID TID information field 315, in Multi-STA BA frame 305. Multi-STA BA frame 305 may contain the BSR per AID TID information field 315 as one of the fields in BA Information field 310 as shown below in FIG. 3, to report BSR information.

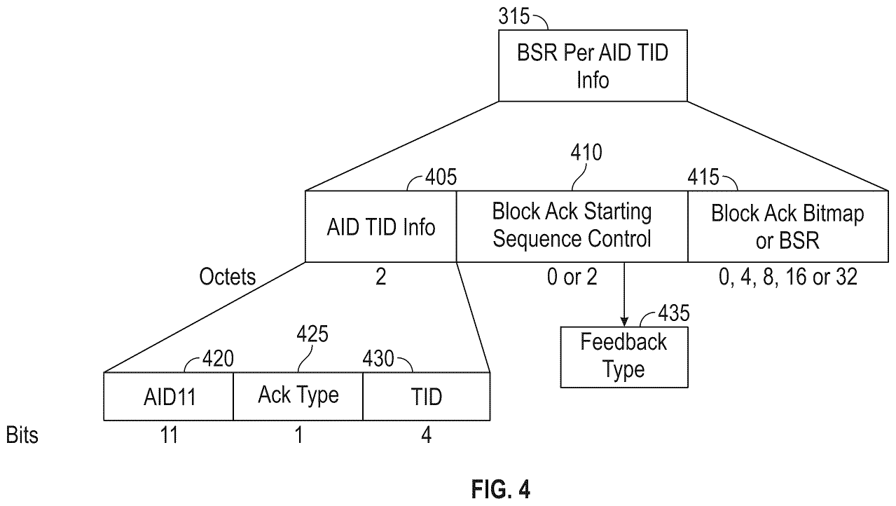

As shown in FIG. 4, BSR Per AID TID information field 315 may comprise AID TID information 405, a BA starting sequence control field 410, and a BA bitmap or BSR field 415 that carries BSR information. BSR per AID TID information field 315 may be identified by defining (then using) specific, standardized value for at least one of an AID11 field 420, an acknowledge type (Ack Type) field 425, or a TID field 430 in AID TID information field 405. In one embodiment, a feedback type field 435 may be included in the BSR Per-AID TID information field, e.g. included in the Block Ack Starting Sequence Control field or in the BSR field, that indicates BSR feedback type. In this case the BSR per AID TID information field is identified based on a combination of one or more of AID11 field 420, the (Ack Type) field 425, the TID field 430 or Feedback Type field 435.

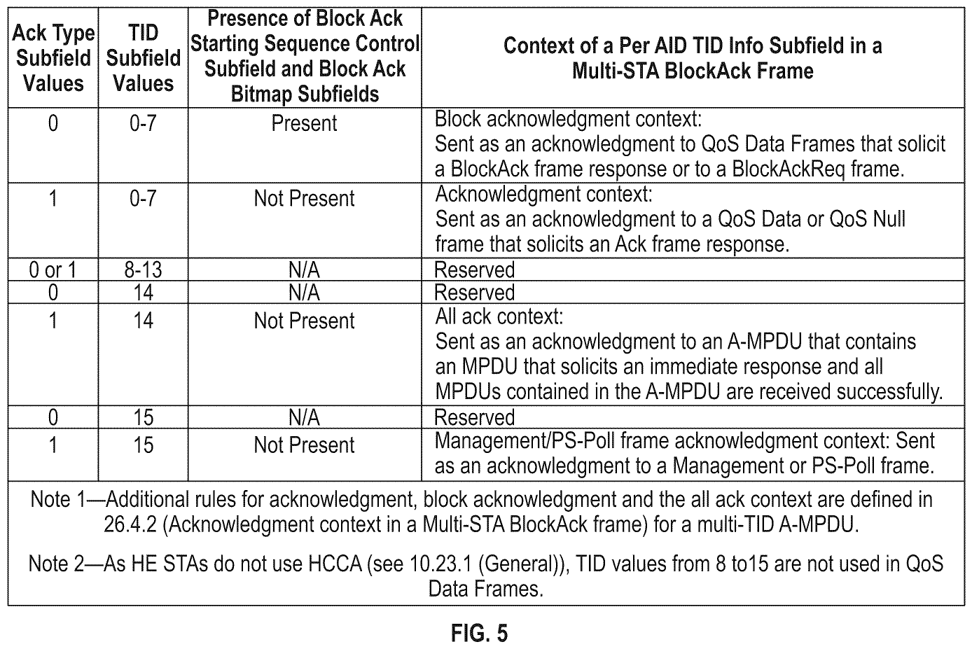

AID11 field 420 may be set to a specific value other than 2045 (i.e., not related to unassociated STAs, see table in FIG. 5). Acknowledge type field 425 may be set to 0 (e.g., currently reserved; can be assigned to indicate presence of BA starting sequence control field 410 and BA bitmap or BSR field 415). TID field 430 may be set to a specific value (e.g., currently 14-15 have special meanings when Ack Type=1, but values 8-13 for any Ack Type, or 14-15 for Ack Type=0 are presently reserved and could be assigned to this purpose) to indicate that the Per AID TID information is a ‘BSR’ Per AID TID information. In one case, the values of AID11, Ack Type and/or TID fields defined for a generic Feedback Type may be used for the BSR Per AID TID information field as well, in which case the BSR Per AID TID information is a Feedback Per AID TID information field and then the Feedback Type field identifies the feedback to be BSR feedback.

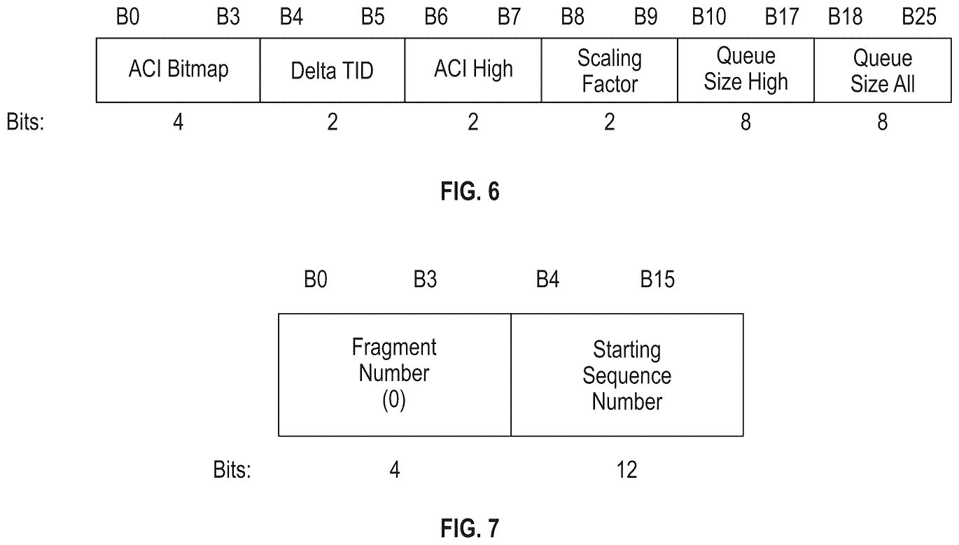

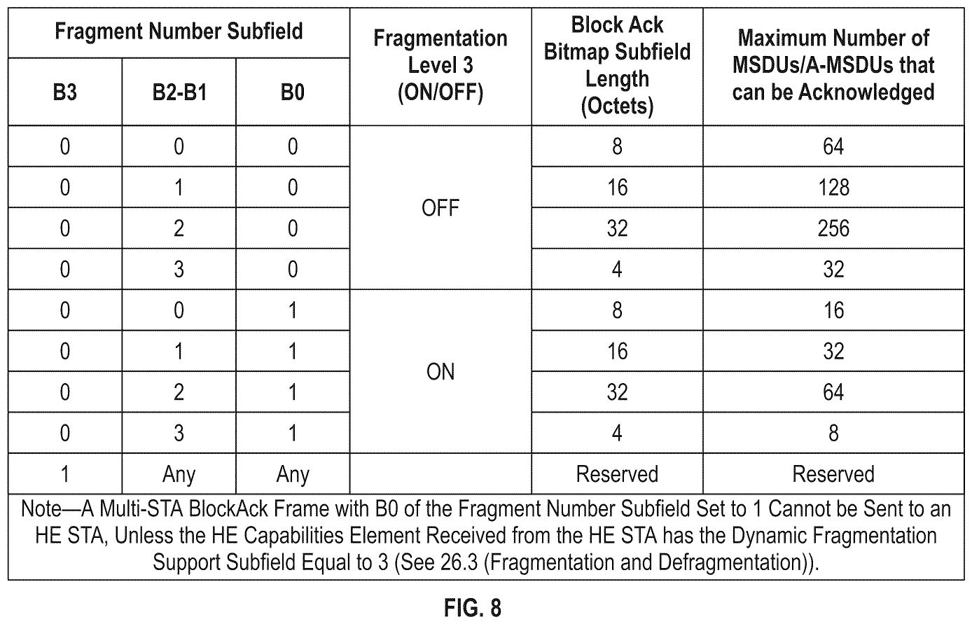

BA bitmap or BSR field 415 may indicate the BSR information and may contain the content of the BSR control subfield as defined in the IEEE 802.11 baseline (e.g., as 26 bits; see 9.2.4.7.4 BSR Control, and as shown in FIG. 6) or an enhanced version of the BSR content or BSR information provided in QoS control field. BA starting sequence control field 410 (see table in FIG. 7) may be used to indicate the size of the ‘Block Ack Bitmap or BSR’ subfield, as defined in IEEE 802.11 baseline (using the Fragment Number subfield setting, as per the table in FIG. 8) or new rules may be defined. In one embodiment, in the case of indicating the BSR information, the size of BA bitmap or BSR field 415 may be set to 4 octets.

Without embodiments of the disclosure, an AP may not receive BSR information from a non-AP STA if the non-AP STA is providing unavailability feedback and cannot send an Aggregated MAC Protocol Data Unit (A-MDPU), and hence may not include a QoS null frame with BSR information. This lack of BSR information may adversely impact the efficiency of the AP's Uplink (UL) trigger scheduling and hence it may be desirable to get the BSR information even when unavailability feedback is provided in non-High Throughput (non-HT), (duplicate) PPDU format.

Once defined for non-HT PPDUs, the same processes may be used for all PPDU types and subvariants. FIG. 5, FIG. 7, and FIG. 8 from IEEE 802.11 baseline may provide further context for the fields defined in the Per AID TID information. Embodiments of the disclosure (as above) may use one or more of these fields to identify that a Per AID TID information is providing BSR information.

Once computing device 900 creates Multi-STA BA frame 305 in stage 220, method 200 may continue to stage 230 where computing device 900 may transmit, in response to receiving the BSRP trigger frame, Multi-STA BA frame 305. For example, when a non-AP STA (e.g., first client device 130) cannot provide/aggregate BSR information in a QoS null frame in a PPDU that is sent in response to a BSRP trigger frame, embodiments of the disclosure may provide that the Multi-STA BA frame in that PPDU provides the BSR information. Ones of the plurality of AP (including the AP that sent the BSRP trigger frame) and the plurality of client devices may receive Multi-STA BA frame 305. Once computing device 900 transmits, in response to receiving the BSRP trigger frame, Multi-STA BA frame 305 in stage 230, method 200 may then end at stage 240.

FIG. 9 shows computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for providing Reporting Buffer Status Report (BSR) information in Multi-Station (STA) Block Acknowledgement (BA) as described above with respect to FIG. 2. Computing device 900, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

### Another Embodiment of Mult-STA BA

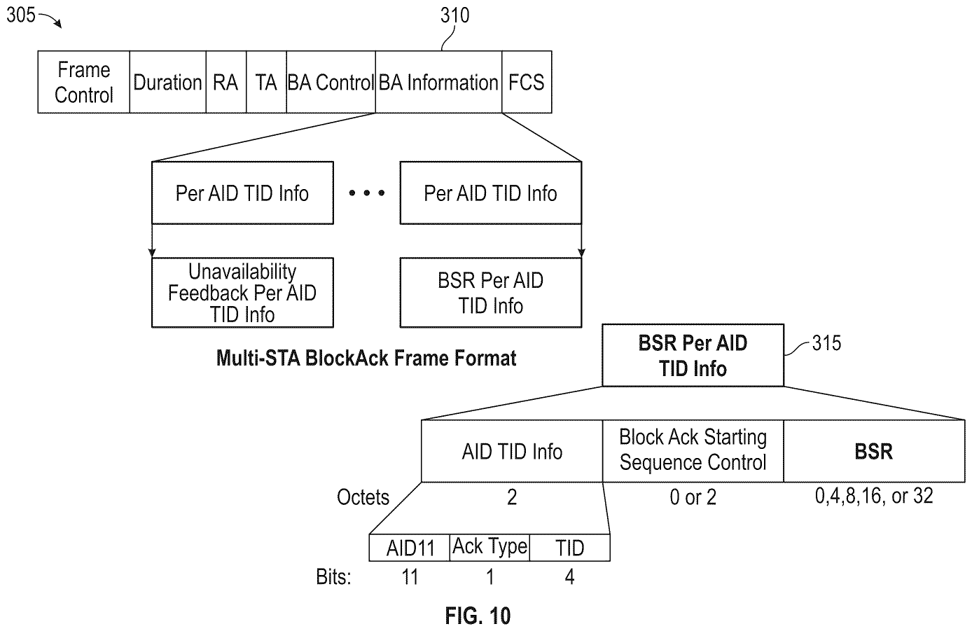

Case 2, as referenced above, may be a concern because the AP may not get BSR information and then may need to send another BSRP Trigger frame in TB PPDU format to get BSR. This may add overhead and delay. One solution may be to allow including BSR information in Multi-STA BA 305 itself for Case 2 as shown in FIG. 10.

Also, in Coordinated Time Division Multiple Access (Co-TDMA) polling phase, a sharing AP intending to share its TxOP may send an ICF (e.g., a BSRP trigger frame) to polled APs, and the polled APs may respond with a Multi-STA BA to the sharing AP. Polled APs may provide BSR information in the Multi-STA BA sent to the sharing AP, to assist the sharing AP in allocation of TxOP portions to polled APs. Accordingly multiple use cases may benefit from allowing BSR information in the Multi-STA BA.

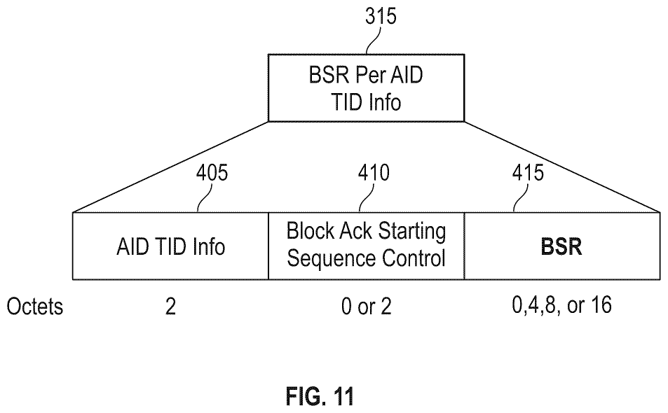

In one approach, as shown in FIG. 11, BSR per AID TID information field 315 may be defined to carry BSR information in the Multi-STA BA frame 305. BSR per AID TID information field 315 carries the BSR information in the Block Ack Bitmap field. A STA may include BSR Per AID TID information in Multi-STA BA frame 305 sent in response to a BSRP Trigger frame, if BSR information is not provided in a QoS Null frame in an A-MPDU that includes the Multi-STA BA. As illustrated in FIG. 11, with respect to BSR Per AID TID information: i) AID11 may be set to a specific value (e.g., 2008 or 2009) if BSR is intended for all STAs or to AID of intended recipient STA; ii) Ack Type field may be set to 0; and iii) TID subfield may be set to a specific value (e.g., value 14). The combination of Ack Type=0 and TID=14 may identify the BSR Per AID TID information. Block Ack Bitmap size may be 4 octets, based on the value of Fragment Number subfield in the Block Ack Starting Sequence Control. Starting Sequence Number field may be reserved.

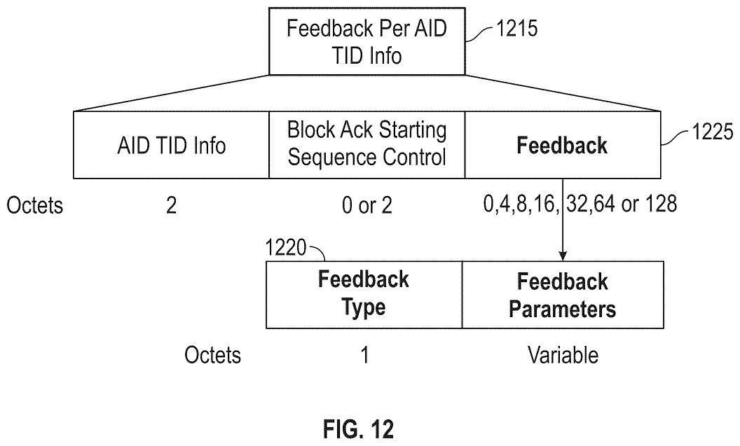

As illustrated by FIG. 12, another approach for adding BSR information in the Multi-STA BA may be to include this in a generic feedback per AID TID information field 1215 that may be defined to report different types of feedback. In IEEE 802.11bn D0.1 , a Feedback Per AID TID information may be defined with Ack Type=0, TID=13 for DUO. The same Feedback Per AID TID information may be used to provide different feedback type information. For example, the following feedback types may be defined, but are not limited to: Unavailability feedback, BSR feedback, and Delay feedback (for real time delay of MPDUs in TX queues). Consistent with embodiments of the disclosure, these feedback types may be reported using either Option A or Option B as described below.

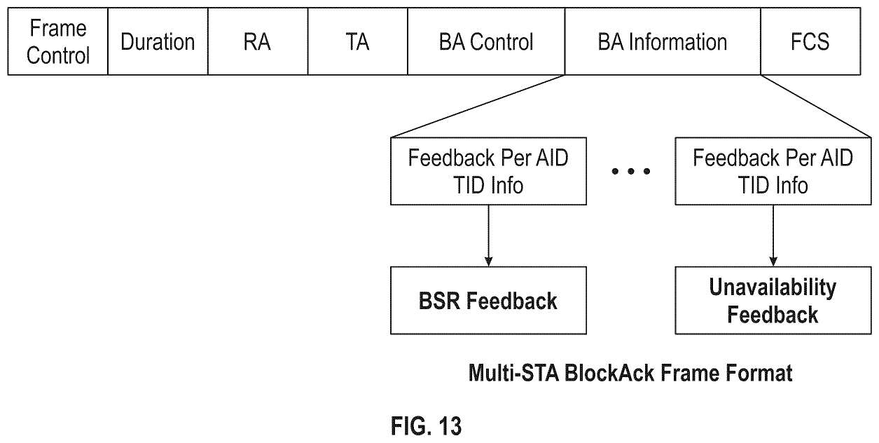

With option A, one feedback per AID TID information field 1215 may carry a single feedback type 1220. In a feedback field 1225, feedback type 1220 (e.g., 1 octet) may be included and may be set to indicate the type of feedback being reported. The Multi-STA BA may carry multiple such feedback per AID TID information fields to report multiple feedback. For example, as shown in FIG. 13 one may be included for BSR feedback, and one for unavailability reporting when STA is providing both information. For each feedback type, the set of parameters may be defined that may be provided in the feedback parameters. FIG. 13 shows two feedback per AID TID information fields included in the Multi-STA Block Ack frame, one for BSR feedback and one for Unavailability Feedback thus distinguished based on feedback type within the per AID TID information field. If the STA has to report dynamic unavailability, then in response to a BSRP Trigger, in the Multi-STA BA it may include both BSR feedback and unavailability feedback.

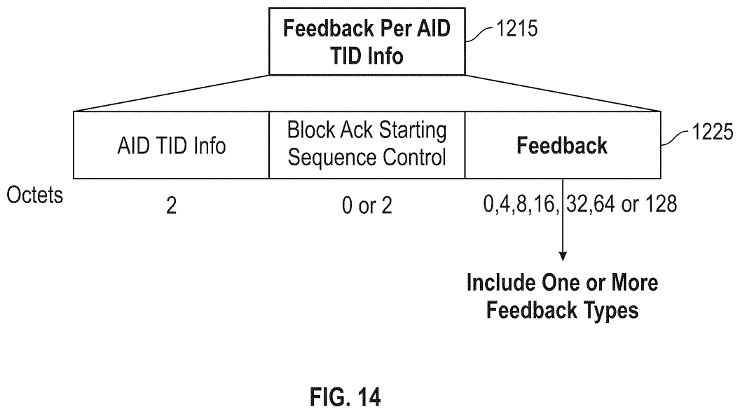

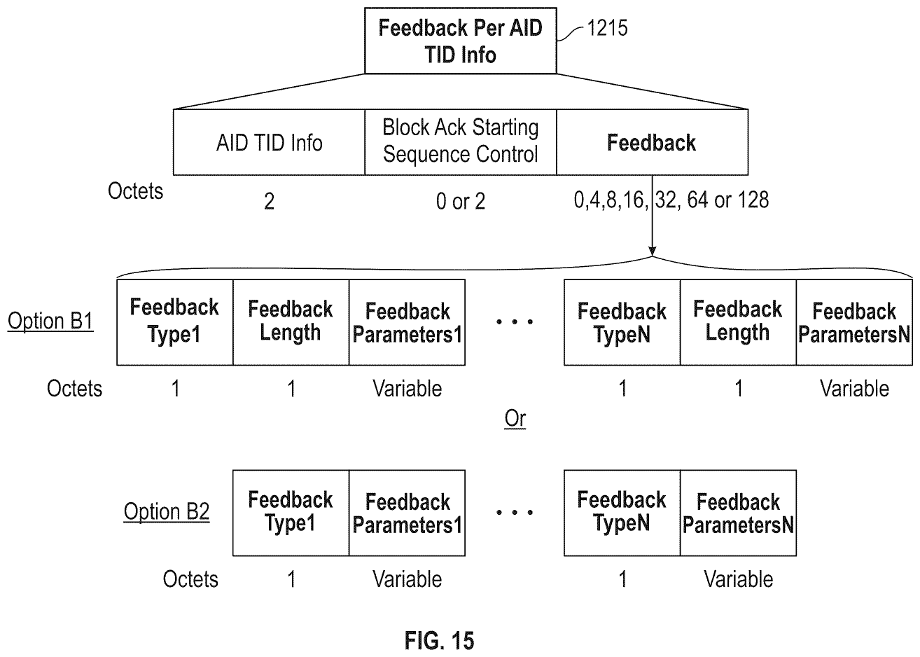

With option B as illustrated by FIG. 14, a single feedback per AID TID information field may carry multiple feedback types. Option B may have three variations, option B1, option B2, and option B3. As illustrated by FIG. 15, in option B1, feedback may include a list of TLV (Feedback Type, Length, Value (Feedback Parameters)) fields, where each TLV may provide information for one feedback type. As illustrated by FIG. 15, in option B2, feedback may include a list of TV (Feedback Type, Value (Feedback Parameters)) fields, where each TV provides information for one feedback type. In this case, length of the feedback value may be fixed based on the type of the feedback.

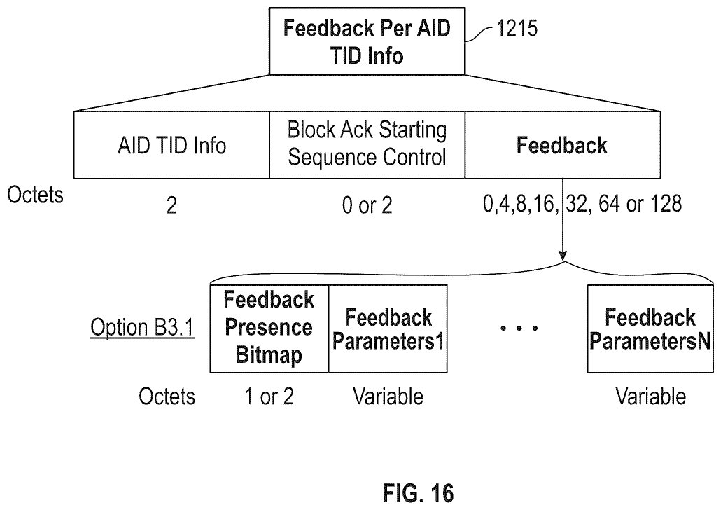

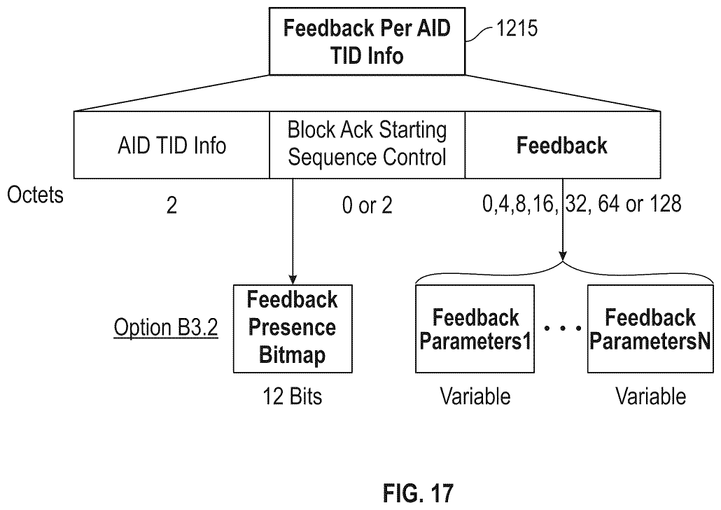

As illustrated by FIG. 16 and FIG. 17, in option B3, feedback may include a list of values (Feedback Parameters) fields. No separate Type and Length fields may be included to indicate what feedback values are included. The first 1 or 2 octets of the feedback field may be used as presence bitmap for indicating presence of specific feedback types in a defined order (FIG. 16 as option B3.1). In another alternative (FIG. 17 as option B3.2), the Starting Sequence Number field in the Block Ack Starting Sequence Control field may be used to indicate Presence Bitmap for Feedback types included in the Feedback field.

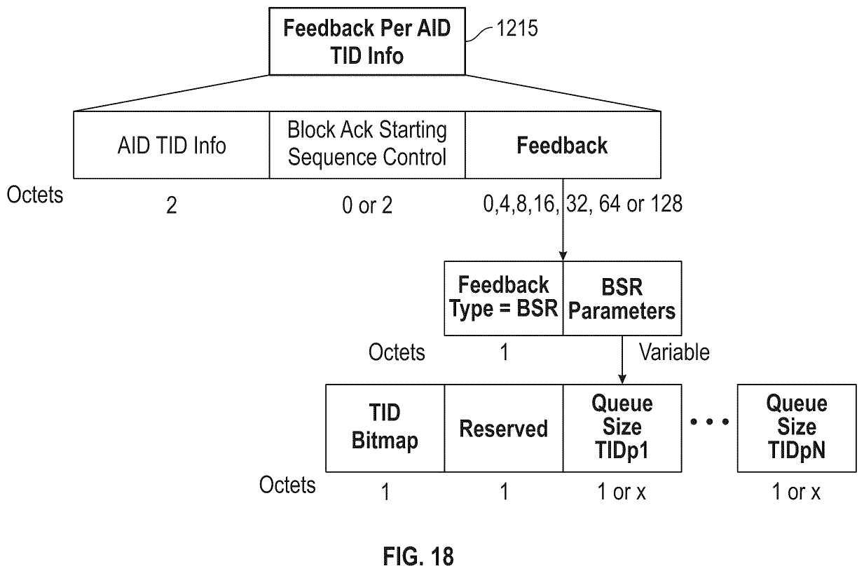

FIG. 18 illustrates BSR feedback type. As shown in FIG. 18, BSR carried in the feedback field may provide BSR information based on BSR A-Control field or any enhanced BSR A-Control field that gets defined. Alternatively, the BSR information carried in the feedback field may provide BSR based on per TID, as provided in baseline using the Queue Size (in QoS Control). A TID Bitmap may be included indicating a set of TIDs for which BSR information is included. For each TID (from 0 to 7) for which BSR is included, the corresponding bit in the TID Bitmap may be set to 1. The BSR information may be provided in the form of ‘Queue Size’ which could be 1 octet or 2 octets. Alternatively, a list of (TID, Queue Size) tuples may be included, providing BSR per TID. However, this may be a larger overhead than including a TID Bitmap. This format of BSR information may be provided using either Option A or Option B as described for the second Approach 2, or for the first approach using a different BSR Per AID TID information field.

### Yet Another Embodiment of Multi-STA BA

When an AP sends a BSRP Trigger frame as ICF for Dynamic Unavailability Operation (DUO) or any other reason, it may not get BSR information when Multi-STA BA response as ICR is provided in non-HT (duplicate) PPDU, since QoS Null with BSR cannot be aggregated. Embodiments of the disclosure may allow including BSR information in the Multi-STA BA itself.

The BSR information may be included in the Multi-STA BA for both when a Multi-STA BA is sent using non-HT (duplicate) PPDU or when it is sent using TB PPDU. In the latter case, if QoS Null is aggregated with Multi-STA BA, it may carry another Control field in A-Control and hence in those cases it may benefit to allow for the inclusion of BSR information in the Multi-STA BA itself even in this case. Also, in the Co-TDMA polling phase, polled APs may respond with Multi-STA BA to a sharing AP. Polled APs may provide BSR information in Multi-STA BA to assist the sharing AP in allocation of TxOP portions to polled APs. Accordingly, multiple use cases may benefit from allowing BSR information in Multi-STA BA.

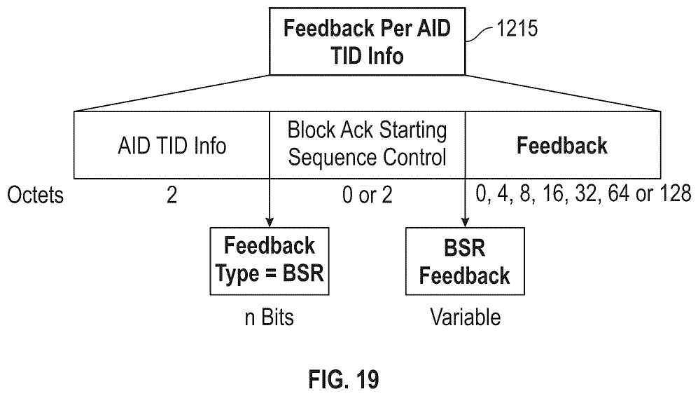

As illustrated by FIG. 19, BSR feedback may be provided in the Feedback Per AID TID information field in a Multi-STA BA. The Feedback Type field may indicate ‘BSR Information’ that may be indicated either in the ‘Block Ack Starting Sequence Control’ field (as shown) or in the Feedback field itself.

BSR feedback carried in the Feedback Per AID TID field in a Multi-STA BA may provide BSR based on: i) the Queue Size field defined for the QoS Control field in 802.11 baseline; ii) the Queue Size Indicator field being defined in IEEE 802.11bn for Enhanced BSR Control field. This may be used for reporting higher BSR queue size as defined by the Enhance BSR; or iii) BSR control defined in A-Control.

The BSR feedback in a Multi-STA BA may indicate the set of one or more TIDs for which BSR information is provided. In addition, the BSR feedback in Multi-STA BA may indicate the format/encoding type for the BSR information for each TID. This may indicate whether BSR information is based on: i) the Queue Size field defined in QoS Control; or ii) the Queue Size Indicator field defined for Enhanced BSR in IEEE 802.11bn. Furthermore, the BSR feedback in a Multi-STA BA may provide the BSR information for each indicated TID in the format/encoding type of the BSR information (using i or ii above) indicated for that TID.

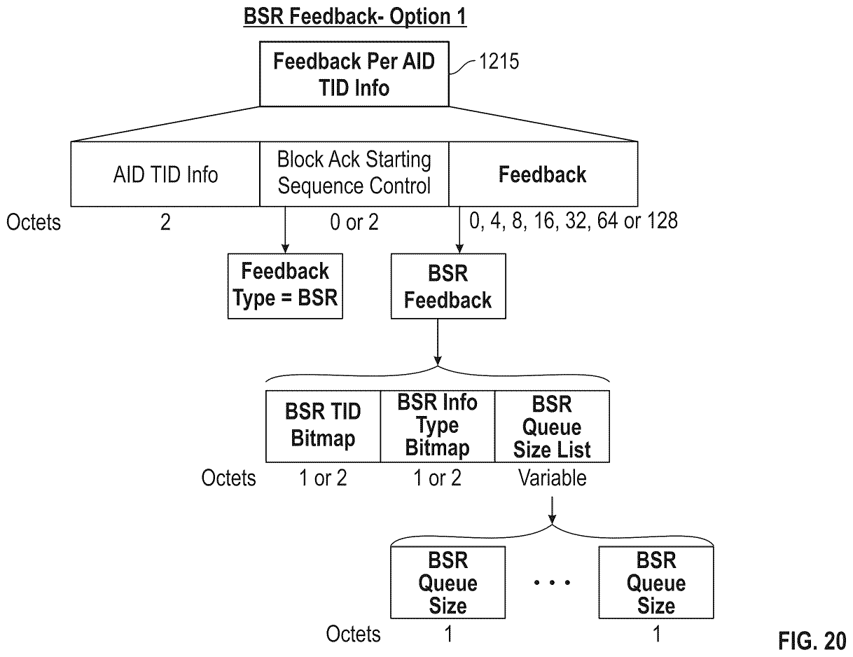

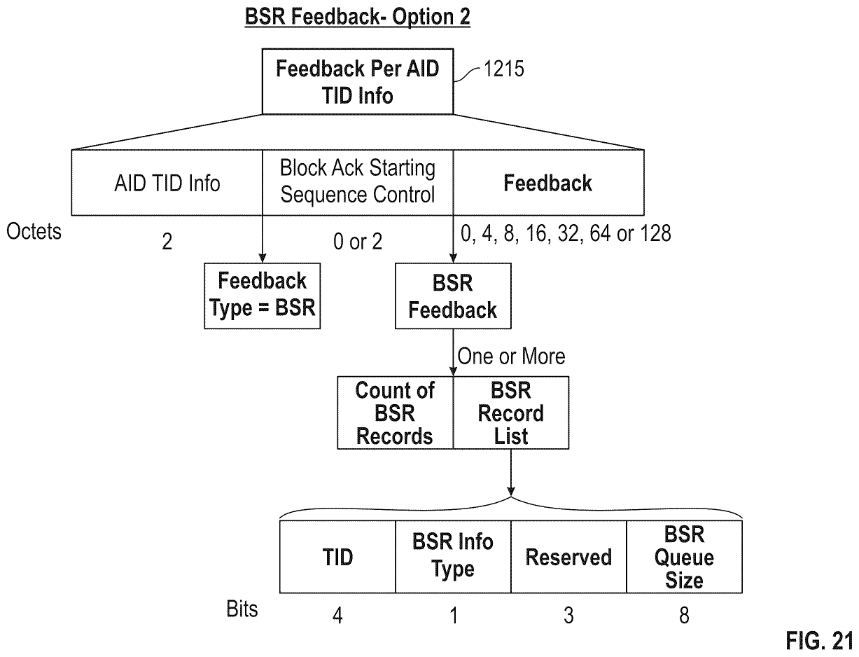

FIG. 20 and FIG. 21 illustrate example format options for BSR feedback. As shown in FIG. 20 option 1 may include a BSR TID Bitmap indicating a set of TIDs for which BSR information is included. For each TID (e.g., from 0 to 7) for which BSR is included, the corresponding bit in the BSR TID Bitmap may be set to 1. Furthermore, this option may include a BSR information Type Bitmap that indicates the format/encoding type of BSR information for each TID. This bitmap may have the same size as BSR TID Bitmap. Each bit in this bitmap may correspond to a TID and may be set to a particular value (0 or 1) to indicate that the BSR information is provided using either format A) or B). For example, a bit may be set to 1 to indicate that the BSR information is provided using format B (Enhanced BSR format from IEEE 802.11bn). A separate BSR Queue Size for indicating queue size for each TID may also be included.

As shown in FIG. 21, with option 2, BSR feedback may include a list of BSR records, where each BSR record may provide BSR for each TID. Such a BSR record may include a set of (TID, BSR information Type, BSR Queue Size) fields, where the BSR information type defines the format for BSR Queue Size (e.g., whether format A) or B)) for the corresponding TID. A Non-AP STA may include one or more of such BSR records in the Feedback field of the Feedback Per AID TID information field. A count field may be included (in the Feedback field or in the Block Ack Starting Sequence Control field) to indicate how many such BSR records are included.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 900 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by a computing device, a Buffer Status Report Poll (BSRP) trigger frame;
creating a Multi-Station (STA) Block Acknowledgement (BA) frame, wherein the Multi-STA BA frame comprises Buffer Status Report (BSR) information; and
transmitting, in response to receiving the BSRP trigger frame, the Multi-STA BA frame.

2. The method of claim 1, wherein the BSRP trigger frame comprises one of a BSRP non-trigger based (NTB) Trigger frame and a BSRP Trigger frame.

3. The method of claim 1, wherein the BSR information is carried in a Per Association Identifier (AID) Traffic Identifier (TID) information field.

4. The method of claim 3, wherein the Per AID TID information field comprises a BSR field carrying the BSR information.

5. The method of claim 3, wherein the Per AID TID information field comprises a BA starting sequence control field indicating size of a BSR field carrying the BSR information.

6. The method of claim 5, wherein the BA starting sequence control field includes a feedback type field that indicates a BSR feedback type.

7. The method of claim 6, further comprising identifying whether the Per AID TID Information field carries the BSR information based on one or more of an AID11 field, an Ack type field, a TID field, and the feedback type field.

8. The method of claim 6, wherein the per AID TID information field comprises an AID TID information.

9. The method of claim 8, wherein the AID TID information comprises an AID11 field.

10. The method of claim 8, wherein the AID TID information comprises an acknowledgement (Ack) type field.

11. The method of claim 8, wherein the AID TID information comprises a TID field.

12. The method of claim 1, wherein the BSRP trigger frame indicates that the BSR information is requested in the Multi-STA BA frame.

13. The method of claim 1, wherein the computing device comprises a client device.

14. A system comprising:
a memory storage; and
a processing unit coupled to the memory storage, wherein the processing unit is operative to:
receive a Buffer Status Report Poll (BSRP) trigger frame;
create a Multi-Station (STA) Block Acknowledgement (BA) frame, wherein the Multi-STA BA frame comprises Buffer Status Report (BSR) information; and
transmit, in response to receiving the BSRP trigger frame, the Multi-STA BA frame.

15. The system of claim 14, wherein the BSRP trigger frame comprises one of a BSRP non-trigger based (NTB) Trigger frame and a BSRP Trigger frame.

16. The system of claim 14, wherein the BSR information is carried in a Per Association Identifier (AID) Traffic Identifier (TID) information field.

17. A non-transitory computer-readable medium that stores a set of instructions which when executed perform a method executed by the set of instructions comprising:
receiving, by a computing device, a Buffer Status Report Poll (BSRP) trigger frame;
creating a Multi-Station (STA) Block Acknowledgement (BA) frame, wherein the Multi-STA BA frame comprises Buffer Status Report (BSR) information; and
transmitting, in response to receiving the BSRP trigger frame, the Multi-STA BA frame.

18. The non-transitory computer-readable medium of claim 17, wherein the BSR information is carried in a Per Association Identifier (AID) Traffic Identifier (TID) information field.

19. The non-transitory computer-readable medium of claim 18, wherein the Per AID TID information field comprises a BSR field carrying the BSR information.

20. The non-transitory computer-readable medium of claim 18, wherein the Per AID TID information field comprises a BA starting sequence control field indicating size of a BSR field carrying the BSR information.
